(19) United States
(12) Patent Application Publication
(10) Pub. No.: US 2005/0076560 A1
(43) Pub. Date: Apr. 14, 2005

(54) Alkynylsilanes as fuels and rocket propellants

(76) Inventors: David B. Wiley, Warsaw, OH (US); Gregory Kaplan, Bexley, OH (US); Thomas Dobbins, Howard, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/229,305

(22) Filed: Aug. 27, 2002

Related U.S. Application Data
(60) Provisional application No. 60/315,146, filed on Aug. 27, 2001.

(51) Int. Cl. C10L 1/28; C07F 7/08

(52) U.S. Cl. 44/320; 556/465

(57) ABSTRACT

Tri- and tetra-substituted ethynylsilanes wherein the substituents are higher homologs of acetylene (e.g., substituted-ethynyl moieties having 3 to 10 carbon atoms) are described, Alkynylsilanes and, more particularly, high energy fuels and rocket propellants containing an alkynylsilane are also provided.

### CROSS REFERENCE TO RELATED APPLICATION

This application claims the benefit of U.S. Provisional Application No. 60/315,146, filed Aug. 27, 2001.

### BACKGROUND OF THE INVENTION

The present invention relates to alkynylsilanes and, more particularly, to high energy fuels and rocket propellants containing an alkynylsilane.

Several alkynylsilanes have been previously prepared by other investigators and described in the literature. Examples include trimethylsilylacetylene and trimethylsilyl-1 propyne (both articles of commerce), and tetraethynylsilane. However, while the mono- and di-ethynyl silanes heretofore described in the literature arc stable, attempts to incorporate three or four acetylene moieties have resulted in unstable compounds. Davidsohn, W. and Henry, M., J. Organometallic Chem. (1966) 5, 29, describe tetraethynylsilane as an auto-sublimable solid at room temperature that tends to explode on rapid heating. Due to the instability of tetraethynylsilane, it has only been isolated in small quantities and identified by its mass and infrared spectra. The instability of the tri- and tetra substituted ethynylsilanes has limited further investigation of these compounds.

Prior art rocket propellants typically contain kerosene or a particular kerosene fraction including paraffins, naphthalene and aromatics known as RP-1. Compounds with high internal bond energies have recently been investigated in an effort to develop fuels at lower cost and increased performance. One such candidate is a heptane known as quadricyclane which has been proposed as an additive to or replacement for RP-1 or kerosene, as set forth in U.S. Pat. No. 5,616,882 to Nichols et al., which is incorporated herein by reference.

### SUMMARY OF THE INVENTION

The present invention is directed to stable alkynylsilanes and to the use of alkynylsilanes as fuels and rocket propellants.

Alkynylsilanes having the general formulae (I) to (IV) 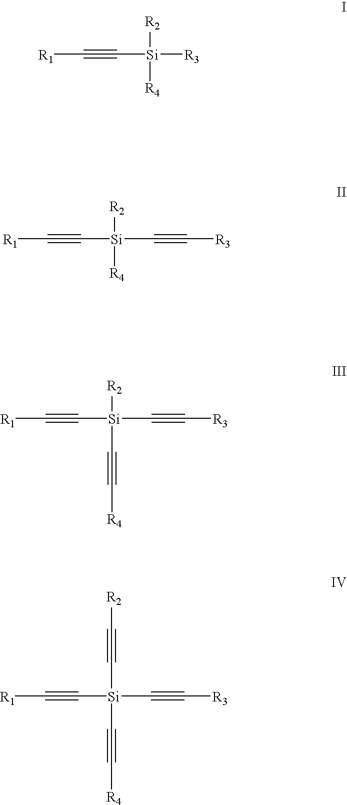
wherein R₁, R₂, R₃, and R₄ are the same or different and represent hydrogen, an alkyl group having 1 to 10 carbon atoms, an alkenyl group having 2 to 10 carbon atoms, an aryl group having 6 to 10 carbon atoms, an amino group, an alkylamino group having 1 to 10 carbon atoms, an alkoxy group having 1 to 10 carbon atoms, a mercapto group, a silyl group, an alkynylsilyl group, a siloxyl group, a silazo group or combinations thereof, hereinafter referred to as “substituted ethynylsilanes,” offer many advantages as fuels and rocket propellants, yet have not heretofore been proposed for this application. The term “substituted ethynylsilanc” as used herein refers to a compound including a silicon atom substituted by one or more ethynyl groups that are substituted as described herein.

The advantages of substituted ethynylsilanes include:
High bond energy; resulting in high specific impulse (“ISP”) when employed as rocket propellants.
Comparatively high density (typically 0.88 or higher versus 0.80 for kerosene).
Suitable for use as a fuel in conjunction with conventional oxidizers such as liquid oxygen, nitrogen tetroxide, and hydrogen peroxide.
Form combustion products of low molecular weight (with the proper fuel-to-oxidizer ratio) that are non-toxic or minimally toxic.
Chemical compatibility (inertness) with non-polar fuels (e.g., kerosene) and polar fuels (e.g., methanol).
Physical compatibility (miscibility or solubility) with non-polar hydrocarbon fuels (e.g., kerosene) and polar fuels (e.g., methanol).

As additives to enhance the performance characteristics of conventional propellants (e.g., kerosene), many of these compounds offer a multitude of advantages over quadricyclane which has been widely promoted for this application:
Low toxicity
Stability over a wide range of temperatures and in contact with a wide variety of metals, long shelf life.
High flash points, combustible but not flammable. Will not alter the transportation classification or handling characteristics when added to fuels like kerosene.
Comparative case of synthesis from readily available and inexpensive precursors.

In accordance with one aspect of the present invention, stable tri- and tetrasubstituted ethynylsilanes are provided. These stable ethynylsilanes are represented by the formula (III) or (IV): 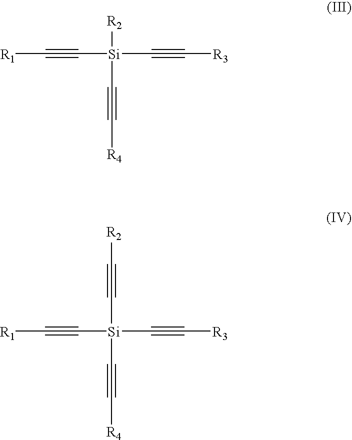
wherein R₁, R₂, R₃, and R₄ are the same or different and represent hydrogen, an alkyl group having 1 to 10 carbon atoms, an alkenyl group having 2 to 10 carbon atoms, an aryl group having 6 to 10 carbon atoms, an amino group, an alkylamino group having 1 to 10 carbon atoms, an alkoxy group having 1 to 10 carbon atoms, a mercapto group, a silyl group, an alkynylsilyl group, a siloxyl group, a silazo group or combinations thereof, provided that no more than two of R₁, R₂, R₃, R₄ are a hydrogen atom.

In accordance with another aspect of the invention, fuels containing alkynylsilanes are provided. These fuels can be used in a variety of applications including, but not limited to, rocket fuels or propellants, internal combustion fuels and turbine fuels. Fuel compositions according to this aspect of the invention include an alkynylsilane represented by the formula (I), (II), (III) or (IV) as provided above, wherein R₁, R₂, R₃, and R₄ are the same or different and represent hydrogen, an alkyl group having 1 to 10 carbon atoms, an alkenyl group having 2 to 10 carbon atoms, an aryl group having 6 to 10 carbon atoms, an amino group, an alkylamino group having 1 to 10 carbon atoms, an alkoxy group having 1 to 10 carbon atoms, a mercapto group, a silyl group, an alkynylsilyl group, a siloxyl group, a silazo group or combinations thereof

When utilized as rocket propellants the fuels in accordance with the present invention are brought into contact with an oxidizer to form the propellant. Accordingly, another aspect of the present invention relates to a method for forming a propellant by bringing a fuel containing an alkynylsilane into contact with an oxidizer.

### DETAILED DESCRIPTION OF THE INVENTION

The present invention is directed to stable alkynylsilanes and to the use of alkynylsilanes as fuels and rocket propellants. The substituted ethynylsilanes as described herein can provide high energy fuels and rocket propellants.

The term “alkyl group” as used herein includes straight chain, branched chain and cyclic alkyl groups. The alkyl groups may have 1 to 10, more specifically 1 to 6 and in certain embodiments, 1 to 3 carbon atoms. The alkyl groups on the ethynylsilanes described herein may be substituted with one or more functional groups, e.g., amine, hydroxyl, an olefinic group such as vinyl or an allyl group, or the like.

If two or more of the ethynyl groups are unsubstitited, the molecule tends to become more unstable. To our knowledge, this instability is severe and has only been documented in the case of the tri- and tetraethynylsilanes the unsubstituted ethynyl groups. Without wishing to be bound by theory, it is believed that compounds that contain more than two alkyl-substituted acetylene or ethynyl groups will exhibit enhanced stability over the less alkyl-substituted molecules—even if the other sites are unsubstituted.

In addition to alkyl groups, the ethynyl groups can also be substituted with alkenyl (up to C10), aryl (up to C10), or combinations of alkyl, alkenyl (C2-10), and aryl groups (C6-10).

Substituted alkynylsilanes as described herein can be synthesized by reacting alkali metal alkynides with halosilanes. Using this synthetic method trimethylsilyl-1-propyne can be prepared from sodium propynilide and chlorotrimethylsilane, dimethyl-di(1-propynl)silane can be prepared from sodium propynilide and dichlorodimethylsilane, methyl-tri(1-propynyl)silane can be prepared from sodium propynilide and trichloromethylsilane and tetra(1-propynyl)silane can be prepared from sodium propynilide and tetrachlorosilane.

Alternatively the corresponding Grignard compounds of the various alkynes can be reacted in solvents like tetrahydrofuran with chlorosilanes. Using this synthetic method trimethylsilyl-1-propyne can be prepared from 1-propynylmagnesium halide and chlorotrimethylsilane, dimethyl-dipropynylsilane can be prepared from 1-propynylmagnesium halide and dichlorodimethylsilane, methyl-tripropynylsilane can be prepared from 1-propynylmagnesium halide and trichloromethylsilane and tetrapropynylsilane can be prepared from 1-propynylmagnesium halide and tetrachlorosilane.

Examples of the alkynes useful in this reaction include propyne, 1-butyne, and higher (up to C10) acetylene and polyacetylene homologs; vinylacetylene and other enynes such as 3-methyl-3-buten-1-ynyl; phenylacetylene and other aromatic acetylenic compounds such as ethynylstyrenes, ethynylnaphthalenes, and similar compounds.

Using these convenient synthetic methods, a wide range of compounds and mixtures of compounds can be produced with properties tailored to specific applications. Properties such as specific impulse, melting point, boiling point, and solubility in various solvents can be predicted and achieved. For example, tetra(1-propynyl)silane, a symmetrical molecule, is a solid melting at 174 degrees C. The melting point can be lowered dramatically by introducing asymmetry: for example, methyl-tri(1-propynyl)silane melts at 90 degrees C. The melting point can be lowered even further to introducing a substituent of higher molecular weight: ethyl-tri(1-propynyl)silane, n-propyl-tri(1-propynyl)silane, and butyl-tri(1-propynyl)silane are all liquids at room temperature and have increasingly higher boiling points.

It has been found that when the substituents of tri- and tetra-substituted ethynylsilanes are higher homologs of acetylene (e.g., substituted ethynyl moieties having 3 to 10 carbon atoms), the stability of the molecule is increased. For example, tetra(1-propynyl)silane is stable even at temperatures exceeding 200 degrees C., while tetraethynylsilane, because of its instability, has only been isolated in small quantities and identified by its mass and infrared spectra.

As a consequence of this discovery, a wide variety of stable polyalkynylsilanes and polyalkynyldisilanes have been prepared and characterized. Examples of these silanes include but are not limited to compounds of formula (III) and (IV): 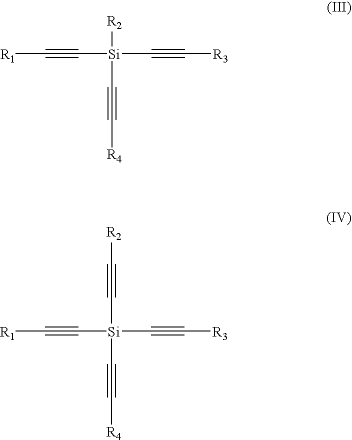
wherein R₁, R₂, R₃, and R₄ represent hydrogen, an alkyl group having 1 to 10 carbon atoms, an amino group, an alkylamino group having 1 to 10 carbon atoms, an alkoxy group having 1 to 10 carbon atoms, a mercapto group, a silyl group, a siloxyl group or a silazo group, provided that no more than two of R₁, R₂, R₃, R₄ are a hydrogen atom.

Specific examples of ethynylsitanes in accordance with the present invention include, but are not limited to, the following:

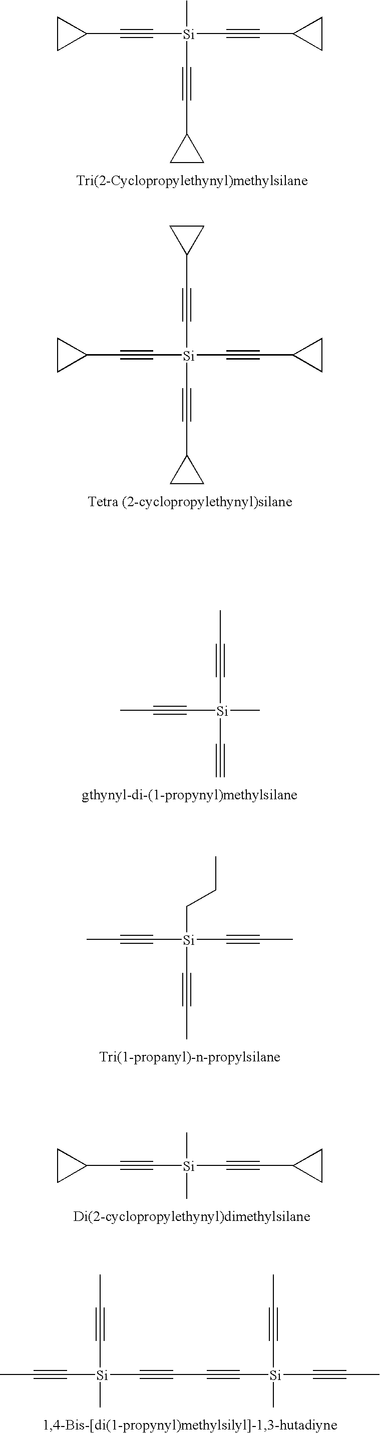

In accordance with one aspect of the present invention, substituted ethynylsilanes are utilized as additives to or replacements for conventional fuels and/or rocket propellants. The substituted ethynylsilanes of the present invention can be used in a range from about 1 to 100% by weight of the total fuel or propellant composition. Examples of fuels that can be used with the alkynylsilanes described herein include saturated hydrocarbons (e.g., heptane, hexane, octane, decate, gasoline, kerosene), unsaturated hydrocarbons (e.g., ethylene, propylene, butadienes, methylacetylene), alcohols (e.g., methanol, ethanol, propanol), organoamines and hydrazines.

When substituted ethynylsilanes are employed as rocket propellants, examples of suitable oxidizers include liquid oxygen, hydrogen peroxide, and nitrogen tetroxide. The oxidizer-to-fuel ratio is typically selected to produce combustion products with minimal molecular weights in order to maximize specific impulse. Mass ratios of oxidizer-to-fuel will typically range from 2:1 to 10:1.

Several of the polysubstituted alkynylsilane compounds investigated have the property of being hypergolic (self-igniting) when nitrogen tetroxide is employed as the oxidizer. Specific examples of alkynyl silanes that are hypergolic with nitrogen tetroxide include, but are not limited to, allyltripropynylsilane and vinyltripropynylsilane. This property is highly desirable in many applications such as maneuvering thrusters where reliable, very rapid ignition in repeated bursts is required.

The present invention is illustrated in more detail by the following non-limiting examples.

### EXAMPLE 1

### Preparation of Propyltripropynylsilane

106 grams of a 17% by wt. dispersion of sodium propynilide in toluene (0.33 moles of contained sodium propynilide) and 15 grams of dimethylformamide were charged to a three-necked flask equipped with a stirrer, addition funnel, and reflux condenser. A solution of 17.7 grams (0.1 moles) of trichloropropylsilane in 10 ml of toluene was added dropwise. The reaction is exothermic, and the temperature was maintained at 50 degrees C. for one hour. The reaction mixture was then quenched by adding 150 ml of 10% hydrochloric acid with vigorous agitation. The mixture was poured into a separatory funnel and allowed to separate into two layers. The supernatant organic layer was charged to a still and toluene removed by distillation to give 10.0 grams (0.053 moles ) of propyltripropynlsilane (53% of theoretical yield).

### EXAMPLE 2

### Preparation of Di-(2-cyclopropylethynyl)dimethylsilane

100 ml of a 2M solution of ethylmagnesiumchloride in tetrahydrofuran (0.20 moles EtMgCl contained) was charged to a three-necked flask equipped with a stirrer, addition funnel, and reflux condenser. 15 grams (0.23 moles) of ethynyl cyclopropane was added dropwise over a period of 20 minutes. After the evolution of ethane ceased, a solution of 12 grams (0.093 moles) of dichlorodimethylsilane in 10 ml of tetrahydrofuran was added dropwise. The reaction is exothermic, and the temperature was maintained at 70 degrees C. for one hour. The reaction mixture was then quenched by adding 100 ml of 10% hydrochloric acid with vigorous agitation. The mixture was poured into a separatory funnel and allowed to separate into two layers. The supernatant organic layer was charged to a still and THF removed by distillation to give 16.6 grams (0.088 moles) of di-(2-cyclopropylethynyl)dimethylsilane (95% of theoretical yield).

### EXAMPLE 3

### Preparation of Tri-(2-cyclopropylethynyl)methylsilane

100 ml of a 2M solution of ethylmagnesiumchloride in tetrahydrofuran (0.20 moles EtMgCl contained) was charged to a three-necked flask equipped with a stirrer, addition funnel, and reflux condenser. 15 grams (0.23 moles) of ethynyl cyclopropane was added dropwise over a period of 20 minutes. After the evolution of ethane ceased, a solution of 9 grams (0.06 moles) of trichloromethylsilane in 10 ml of tetrahydrofuran was added dropwise. The reaction is exothermic, and the temperature was maintained at 70 degrees C. for one hour. The reaction mixture was then quenched by adding 100 ml of 10% hydrochloric acid with vigorous agitation. The mixture was poured into a separatory funnel and allowed to separate into two layers. The supernatant organic layer was charged to a still and THE removed by distillation to give 14.0 grams (0.058 moles) of tri-(2-cyclopropylethynyl )methylsilane (98% of theoretical yield).

1. An alkynylsilane represented by the formula (I) or (II): 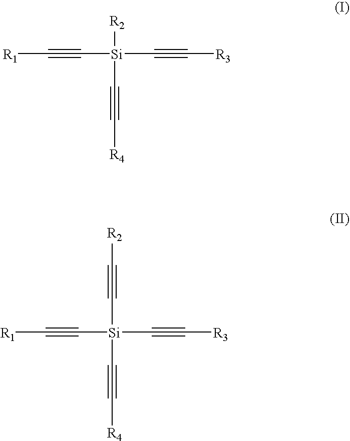
wherein R₁, R₂, R₃, and R₄ arc the same or different and represent hydrogen, an alkyl group having 1 to 10 carbon atoms, an alkenyl group having 2 to 10 carbon atoms, an aryl group having 6 to 10 carbon atoms, an amino group, an alkylamino group having 1 to 10 carbon atoms, an alkoxy group having 1 to 10 carbon atoms, a mercapto group, a silyl group, in alkynylsilyl group, a siloxyl group, a silazo group or combinations thereof provided that no more than two of R₁, R₂, R₃, R₄ are a hydrogen atom.

2. An alkynylsilane in accordance with claim 1 wherein R₁, R₂, R₃, and R₄ are the same or different and represent a hydrogen atom or an alkyl group having 1 to 3 carbon atoms.

3. An alkynylsilane in accordance with claim 2 selected from the group consisting of tetra(1-propynyl)silane, tri(1-propynyl)-n-propylsilane, tri(2-cyclopropylethynyl)methylsilane, and tetra(2-cyclopropylethynyl)silane.

4. An alkynylsilane in accordance with claim 1, which is 1,4-Bis-[di(1-propynyl)methylsilyl]-1,3-butadiyne.

5. A fuel composition comprising an alkynylsilane, wherein said alkynylsilane is represented by the formula (I), (II), (III) or (IV): 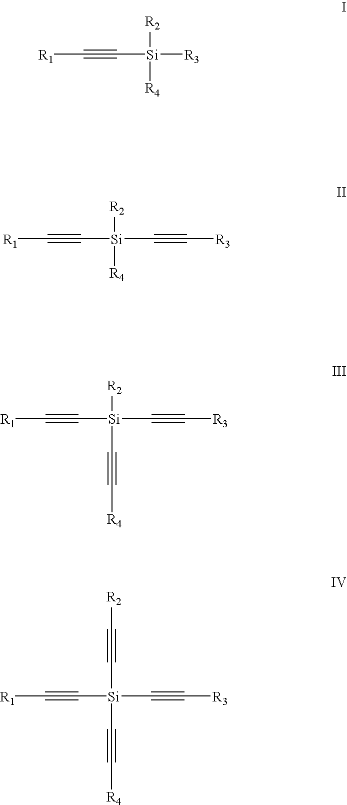
wherein R₁, R₂, R₃, and R₄ are the same or different and represent hydrogen, an alkyl group having 1 to 10 carbon atoms, an alkenyl group having 2 to 10 carbon atoms, an aryl group having 6 to 10 carbon atoms, an amino group, an alkylamino group having 1 to 10 carbon atoms, an alkoxy group having 1 to 10 carbon atoms, a mercapto group, a silyl group, an alkynylsilyl group, a siloxyl group, a silazo group or combinations thereof

6. The fuel composition of claim 5 wherein R₁, R₂, R₃, and R₄ arc the same or different and represent hydrogen or an alkyl group having 1 to 10 carbon atoms.

7. The fuel composition of claim 6 wherein R₁, R₂, R₃, and R₄ are the same or different and represent hydrogen or an alkyl group having 1 to 3 carbon atoms.

8. The fuel composition of claim 5 wherein said alkynylsilane is selected from the group consisting of trimethylsilyl-1-propyne; dimethyl-dipropynylsilane; methyl-tripropynylsilane; tetra(1-propynyl)silane; tri(1-propynyl)-n-propylsilane; tri(2-cyclopropylethynyl)methylsilane; tetra(2-cyclopropylethynyl)silane; di(2-cyclopropylethynyl)dimethylsilane; ethynyl-di-(1-propynyl)methylsilane; 1,4-Bis-[di(1-propynyl)methylsilyl]-1,3-butadiyne and combinations thereof.

9. The fuel composition of claim 5 further comprising a fuel selected from the group consisting of hexane, heptane, octane, decane, methanol, ethanol, propanol, kerosene, gasoline, ethylene, propylene, butadiene, methylacetylene, organoaminc, hydrazine and combinations thereof.

10. The fuel composition of claim 5 wherein said fuel composition is hypergolic when brought into contact with nitrogen tetroxide.

11. The fuel composition of claim 10 wherein said alkynylsilane is selected from the group consisting of allyltripropynylsilane, vinyltripropynylsilane and mixtures thereof.

12. A propellant comprising a fuel composition and an oxidizer wherein said fuel composition comprises an alkynylsilane, wherein said alkynylsilane is represented by the formula (I), (II), (III) or (IV) 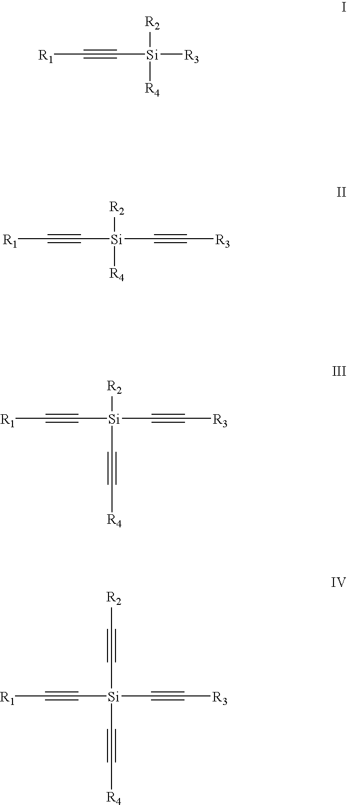
wherein R₁, R₂, R₃, and R₄ are the same or different and represent hydrogen, an alkyl group having 1 to 10 carbon atoms, an alkenyl group having 2 to 10 carbon atoms, an aryl group having 6 to 10 carbon atoms, an amino group, an alkylamino group having 1 to 10 carbon atoms, an alkoxy group having 1 to 10 carbon atoms, a mercapto group, a silyl group, an alkynylsilyl group, a siloxyl group, a silazo group or combinations thereof.

13. The propellant of claim 12 wherein R₁, R₂, R₃, and R₄ are the same or different and represent hydrogen or an alkyl group having 1 to 10 carbon atoms.

14. The propellant of claim 13 wherein R₁, R₂, R₃, and R₄ are the same or different and represent hydrogen or an alkyl group having 1 to 3 carbon atoms.

15. The propellant of claim 12 further comprising a fuel selected from the group consisting of hexane, heptane, octane, decane, methanol, ethanol, propanol, kerosene, gasoline, ethylene, propylene, butadiene, methylacetylene, organoamine, hydrazine and combinations thereof.

16. The propellant of claim 12 wherein said oxidizer is selected from the group consisting of liquid oxygen, hydrogen peroxide and nitrogen tetroxide.

17. The propellant of claim 12 wherein said alkynylsilane is selected from the group consisting of allyltripropynylsilane, vinyltripropynylsilane and mixtures thereof and said oxidizer comprises nitrogen tetroxide.

18. A method for producing a propellant comprising contacting a fuel with an oxidizer wherein said fuel comprises an alkynylsilane, wherein said alkynylsilane is represented by the formula (I), (II), (III) or (IV) 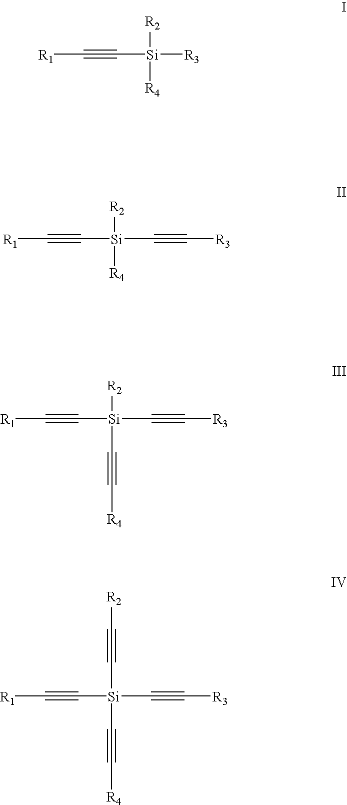
wherein R₁, R₂, R₃, and R₄ are the same or different and represent hydrogen, an alkyl group having 1 to 10 carbon atoms, an alkenyl group having 2 to 10 carbon atoms, an aryl group having 6 to 10 carbon atoms, an amino group, an alkylamino group having 1 to 10 carbon atoms, an 10 alkoxy group having 1 to 10 carbon atoms, a mercapto group, a silyl group, an alkynylsilyl group, a siloxyl group, a silazo group or combinations thereof.

19. The method of claim 18 wherein R₁, R₂, R₃, and R₄ are the same or different and represent hydrogen or an alkyl group having 1 to 10 carbon atoms.

20. The method of claim 19 wherein R₁, R₂, R₃, and R₄ are the same Or different and represent hydrogen or an alkyl group having 1 to 3 carbon atoms.

21. The method of claim 18 wherein said alkynylsilane is selected from the group consisting of trimethylsilyl-1-propyne; dimethyl-dipropynylsilane; methyl-tripropynylsilane; tetra(1-propynyl)silane; tri(1-propynyl)-n-propylsilane; tri(2-cyclopropylethynyl)methylsilane; tetra(2-cyclopropylethynyl)silane, di(2-cyclopropylethynyl)dimethylsilane; ethynyl-di-(1-propynyl)methylsilane; 1,4-Bis-[di(1-propynyl)methylsilyl]-1,3-butadiyne and combinations thereof.

22. The method of claim 18 wherein said fuel composition further comprises a fuel selected from the group consisting of hexane, heptane, octane, decane, methanol, ethanol, propanol, kerosene, gasoline, ethylene, propylene, butadiene, methylacetylene, organoamine, hydrazine and combinations thereof.

23. The method of claim 18 wherein said alkynylsilane is selected from the group consisting of allyltripropynylsilane, vinyltripropynylsilane and mixtures thereof and said oxidizer comprises nitrogen tetroxide.

24. The method of claim 18 wherein said oxidizer is selected from the group consisting of liquid oxygen, hydrogen peroxide and nitrogen tetroxide.
